(19) United States
(12) Patent Application Publication
(10) Pub. No.: US 2005/0076506 A1
(43) Pub. Date: Apr. 14, 2005

(54) Method for manufacturing aluminum heat exchanger

(76) Inventor: Kenso Kanada, Chiryu-city (JP)

Correspondence Address: HARNESS, DICKEY & PIERCE, P.L.C., P.O. BOX 828, BLOOMFIELD HILLS, MI, 48303, US

(21) Appl. No.: 10/949,434

(22) Filed: Sep. 24, 2004

(30) Foreign Application Priority Data
Oct. 8, 2003 (JP) 2003-349712

(51) Int. Cl. B21D 53/02; B23P 15/26

(52) U.S. Cl. 29/890.054; 29/890.03

(57) ABSTRACT

A mixture of a low-temperature active-type non-corrosive flux and a low-melting point brazing material consisting of zinc, or zinc-aluminum alloy mainly composed of zinc, is applied to at least one 10 of a plurality of aluminum members 10 to 13, and the plurality of aluminum members 10 to 13 are brazed with each other by heating an assembly of the plurality of aluminum members 10 to 13 at a temperature exceeding a melting activity-initiating point of the non-corrosive flux and a melting point of the low-melting point brazing material.

### BACKGROUND OF THE INVENTION

1. Field of the Invention

The present invention relates to a method for manufacturing an aluminum heat exchanger, formed by brazing a plurality of aluminum members to each other, which is suitably used for a refrigerant condenser, a refrigerant evaporator of a car air-conditioner, a hot water type radiator (a heat core) for heating or a cooling water radiator of a car engine.

2. Description of the Related Art

In Japanese Unexamined Patent Publication No. 62-84868, a method is disclosed for carrying out the brazing of aluminum heat exchanger by using a brazing material, having a low melting point, such as zinc or zinc-aluminum alloy. Concretely, a fluoride type non-corrosive flux is applied to a surface of a tube of the aluminum heat exchanger. Thereafter, the tube is preheated to a temperature in a range from 100 to 200° C. and then the brazing material having a low melting point, such as zinc or zinc-aluminum alloy is applied to the tube surface by a melt-plating method.

Thereafter, the tube and fins of the aluminum heat exchanger are assembled together to be an assembly of a predetermined structure, and the same non-corrosive flux, as used before, is again applied to the surface of the assembly. Then, the assembly is conveyed into a brazing furnace filled with a nitrogen gas and heated at the melting point or higher of the non-corrosive flux and the low-melting point brazing material (450 to 570° C.) to braze the tube and fins with each other.

Also, in Japanese Unexamined Patent Publication No. 6-88695, a method is disclosed for applying a solder composed of a zinc-based alloy mainly composed of zinc (that is, the low-melting point brazing material in the above-mentioned patent document) to a tube surface of an aluminum heat exchanger by a melt-plating method to braze a tube to fins.

In either of the above-mentioned patent documents, as the low-melting point brazing material (solder) composed of zinc or zinc-aluminum alloy is applied to the tube surface, aluminum material forming the tube is heated twice at a melting point of zinc or higher during the melt-plating and the brazing.

As the mechanical strength of aluminum material is lowered due to such a thermal history, it is difficult to reduce the thickness of aluminum material. As a result, a reduction of size or weight and production cost of the aluminum heat exchanger is prevented, as a whole.

### SUMMARY OF THE INVENTION

The present invention has been made to solve the above-mentioned problems and an object thereof is to provide a manufacturing method capable of favorably carrying out the brazing of an aluminum heat exchanger by only one heating.

To achieve the above object, according to the present invention, a method for manufacturing an aluminum heat exchanger formed by brazing a plurality of aluminum members (10 to 13) with each other, comprising the steps of: applying a mixture of a low-temperature active type non-corrosive flux and a low-melting point brazing material consisting of zinc or zinc-aluminum alloy mainly composed of zinc to at least one (10) of the plurality of aluminum members (10 to 13), and brazing the plurality of aluminum members (10 to 13) with each other by heating an assembly of the plurality of aluminum members (10 to 13) at a temperature exceeding a melting activity-initiating point of the non-corrosive flux and a melting point of the low-melting point brazing material, is provided.

The term “aluminum” in the inventive aluminum heat exchanger and aluminium members stands for not only pure aluminum but also for aluminum alloy.

The low melting point referred to in the low-melting point brazing material means that the melting point of the latter is sufficiently lower than that (approximately 600° C.) of Al—Si type brazing material usually used as the brazing material for the aluminum heat exchanger. Concretely, if the low-melting point brazing material is made of pure zinc, the melting point is 419° C.

Zinc-aluminum alloy mainly composed of zinc may be used as the low-melting point brazing material. In this regard, aluminum in a range from approximately 2 to 6% by weight is added thereto. Particularly, if a eutectic crystal alloy of 95% zinc and 5% aluminum by weight is used, it is possible to obtain the low-melting point brazing material having the melting point of 382° C.

Also, while impurities unavoidable from the zinc-aluminum alloy mainly composed of zinc may, of course, be contained therein, a small amount of elements other than aluminum may be added if necessary to further lower the melting point of the low-melting point brazing material. In this text, the term “low-melting point brazing material” stands for a temperature at which the brazing material begins to melt.

The low-temperature active type non-corrosive flux stands for the non-corrosive flux melted and activated in a melting point range of the low-melting point brazing material. By the activation of the non-corrosive flux, the brazing accelerating action is achieved; that is, an oxidized aluminum film is removed and/or molten brazing material is fluidized.

Concretely, the low-temperature active type non-corrosive flux contains CsF. More concretely, it is a mixture compound of CsF and AlF₃. For example, when a ratio of the mixture compound is CsF of 35 mol % and AlF₃ of 65 mol %, the melting activity-initiating point of the non-corrosive flux is 420° C. and a range of melting active temperature is from 420 to 480° C.

The melting activity-initiating point stands for a temperature at which the flux begins to melt and the above-mentioned brazing accelerating action is activated, and the range of melting active temperature stands for a temperature range wherein the melting activation is favorably maintained. In this regard, if the temperature of the non-corrosive flux exceeds the upper limit of the range of melting active temperature, the non-corrosive flux is overheated to rapidly increase the unfavorable gasification of the flux.

Accordingly, when pure zinc is used as low-melting point brazing material and a mixture compound of CsF of 35 mol % and AlF₃ of 65 mol % is used as non-corrosive flux, a plurality of aluminum members (10 to 13) are favorably brazed to each other via molten zinc at the brazing temperature of 460° C., for example.

The melting activity-initiating point and the range of melting active temperature of the non-corrosive flux are adjustable by changing the above-mentioned ratio of the mixture compound.

According to the present invention, a mixture of a low-temperature active type non-corrosive flux and a low-melting point brazing material consisting of zinc or zinc-aluminum alloy mainly composed of zinc is applied to at least one (10) of a plurality of aluminum members (10 to 13) forming an aluminum heat exchanger, and the plurality of aluminum members (10 to 13) are brazed with each other by heating an assembly of the plurality of aluminum members (10 to 13) at a temperature exceeding a melting activity-initiating point of the non-corrosive flux and a melting point of the low-melting point brazing material.

The mixture of the low-temperature active type non-corrosive flux and a low-melting point brazing material is not necessarily heated to a particularly high temperature, but may be applied to the aluminum member at a temperature in the vicinity of the room temperature.

Accordingly, the heating exceeding the melting point of the brazing material is done only once. In addition, it is possible to lower the brazing temperature itself to a great extent in comparison with the conventional brazing temperature (approximately 600° C.) in the prior art brazing method using Al—Si type brazing material. Thereby, it is possible to suppress the reduction of mechanical strength of the aluminum members (10 to 13) in the heat exchanger caused by the thermal history thereof.

As a result, it is possible to effectively reduce the wall thickness of the aluminum members (10 to 13) and reduce the heat energy used for the brazing.

According to the present invention, zinc is diffused over the surface of the aluminum member (10) by the heat during the brazing to form a zinc-diffusion layer. The zinc-diffusion layer exhibits a sacrificial corrosive action for aluminum mother material to prevent through-holes from forming in the aluminum mother material due to the corrosion (pitting), whereby the anti-corrosive property of the aluminum heat exchanger is improved.

As the heating exceeding the melting point of the brazing material (zinc) is done only once during the brazing, the diffusion concentration or the diffusion depth of the zinc-diffusion layer is easily adjustable.

As the powder mixture of the brazing material and the flux is preliminarily prepared and applied to the surface of the aluminum members, it is possible to apply the brazing material and the flux at the same time. Accordingly, in comparison with the conventional method wherein the brazing material and the flux are separately applied to the surface of the members of the heat exchanger assembly, it is possible to simplify the manufacturing process of the aluminum heat exchanger.

As the low-temperature active-type non-corrosive flux does not corrode the aluminum member and the brazing material, even if the flux component is left after the brazing, the corrosion resistance of the aluminum heat exchanger is not adversely effected. Thereby, a post-rinsing for rinsing the brazed aluminum heat exchanger can be eliminated to further simplify the method for manufacturing the aluminum heat exchanger.

According to the present invention, the brazing may be carried out in the air.

As the low-melting point brazing material consisting of zinc or zinc-aluminum alloy mainly composed of zinc is better in melt-fluidity during the brazing than the conventional Al—Si type brazing material, it is possible to ensure the favorable brazing ability even if the atmosphere in the interior of the furnace is air. Accordingly, in comparison with the method wherein the furnace atmosphere is the reductive atmosphere such as nitrogen gas or a low-dew point atmosphere of dehumidified air, it is possible to effectively reduce the plant cost for brazing.

The brazing temperature is preferably in a range from 400 to 530° C.

The lower limit of the brazing temperature is preferably 400° C. or higher in view of sufficiently melting the low-melting point brazing material. Also, if the brazing temperature exceeds 530° C., zinc is excessively diffused in the aluminum member, resulting in the deterioration of mechanical strength and a useless consumption of heating energy. Accordingly, the brazing temperature is preferably in a range from 400 to 530° C.

In the present invention, the low-temperature active type non-corrosive flux may be CsF-containing non-corrosive flux.

In the present invention, a powder of the CsF-containing non-corrosive flux is preferably mixed to a powder of the low-melting point brazing material at a ratio of 40 to 80% by weight.

If the mixing ratio of the CsF-containing non-corrosive flux is lower than 40% by weight, an amount of the flux becomes insufficient relative to an amount of the low-melting point brazing material, which deteriorates the fluidity of the molten brazing material during the brazing. Thereby, the mixing ratio of the flux is 40% by weight or more.

Contrarily, if the mixing ratio of the flux exceeds 80% by weight, there is no problem in the brazing ability. However, as an amount of expensive CsF used increases to increase the flux cost, the mixing ratio of the flux is preferably in a range from 40 to 80% by weight.

In the present invention, the plurality of aluminum members comprise at least one tube (10) through which heat-exchanging fluid flows and fins (11) bonded to the tube, and the tube (10) and the fins (11) are assembled to form a predetermined structure as an assembly, then the mixture is applied to the surface of the assembly, after which the brazing is carried out.

In such a manner, the application of the mixture may be carried out after the tube (10) and the fins (11) are assembled to form a predetermined structure.

According to the present invention, in the method for manufacturing the aluminum heat exchanger, if the mixture is applied to the assembly by spraying a solution of the mixture to the assembly or dipping the assembly into the solution, it is possible to effectively apply the mixture on the surface of the assembly.

In the present invention, the plurality of aluminum members comprise at least one tube (10) through which heat-exchanging fluid flows and fins (11) bonded to the tube (10), and the mixture is applied to the surface of the tube (10) existing alone, then the tube (10) is assembled with the fins (11) to form an assembly of a predetermined structure, after which the brazing is carried out.

As mentioned above, the mixture may be applied to the surface of the tube (10) alone.

According to the present invention, the mixture may be added with a binder to have a predetermined viscosity, and coated on the surface of the tube (10).

As the mixture is assuredly applied to the surface of the tube (10) by the action of the binder, the layer of the mixture can be assuredly maintained until the brazing operation is completed while preventing the application layer of the mixture from peeling off, even if a mechanical process is carried out on the tube (10) after the application of the mixture

### BRIEF DESCRIPTION OF THE DRAWINGS

FIG. 1 is a perspective view of a refrigerant condenser to which is applied a first embodiment of the present invention.

### DESCRIPTION OF THE PREFERRED EMBODIMENTS

The present invention will be described below based on the preferred embodiments thereof.

### First Embodiment

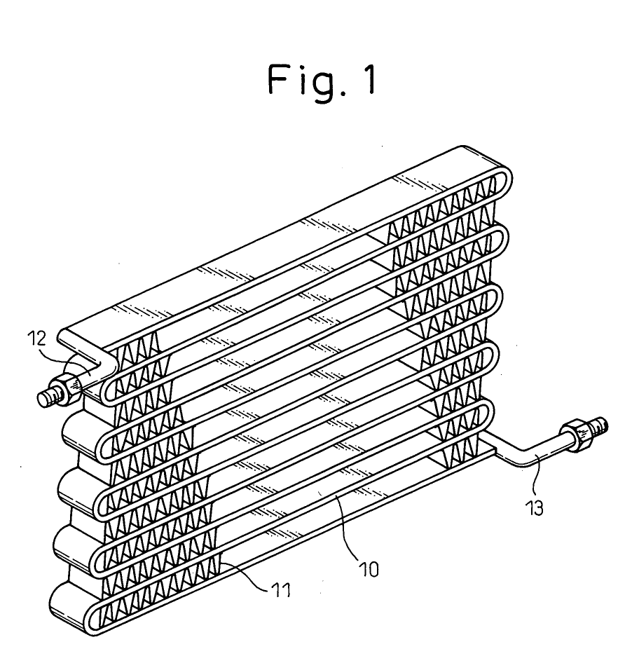

FIG. 1 illustrates a refrigerant condenser for a car air conditioner which is one example of an aluminum heat exchanger manufactured by a first embodiment of the inventive method.

The coolant condenser shown in FIG. 1 has a tube 10 forming a refrigerant passage through which flows highly pressurized refrigerant. The tube 10 is a flat multi-passage tube. As is well-known, the flat multi-passage tube is made by the extrusion molding of aluminum material to have a plurality of refrigerant passages arranged parallel to each other in cross-section. The tube 10 is bent in a zigzag manner to form a plurality of parallel pieces continuously joined together so that a predetermined gap is formed between the adjacent pieces.

A corrugated fin 11 is inserted between every adjacent parallel piece of the tube bent in a zigzag manner and is bonded to the pieces. This corrugated fin 11 is formed by bending a thin aluminum sheet in a corrugated manner. A refrigerant inlet pipe 12 is coupled to one end of the zigzag tube 10 and a refrigerant outlet pipe 13 is coupled to the other end thereof. Both the pipes 12, 13 are also made of aluminum material.

Next, a method for manufacturing the aluminum heat exchanger according to the first embodiment will be concretely explained.

First, the aluminum heat exchanger is assembled. That is, as shown in FIG. 1, the flat multi-passage tube 10 is bent in a zigzag manner, and the corrugated fin 11 is inserted between every adjacent parallel piece. The refrigerant inlet pipe 12 and the refrigerant outlet pipe 13 are located at the opposite ends of the tube 10, respectively. These members 10 to 13 are held in this assembled form by a jig not shown.

Then, a mixture of a low-temperature active type non-corrosive flux and a low-melting point brazing material containing zinc is applied to the assembly.

As described before, the low-temperature active type non-corrosive flux is molten and activated at the brazing temperature of the low-melting point brazing material to achieve the brazing accelerating action; i.e., the removal of the oxidized film from the aluminum surface, the prevention of re-oxidation during the brazing or the improvement in wetness of the brazing material.

The low-temperature active type non-corrosive flux is a powder containing CsF of 35 mol % relative to AlF₃ of 65 mol %. This non-corrosive flux has a melting activity-initiating point of 420° C. and the range of melting active temperature from 420 to 480° C.

Concretely, the low-melting point brazing material is a zinc powder having the degree of purity of 99.9% and the mean particle size of 45 μm. The melting point of zinc used as a low-melting point brazing material is 419° C.

The zinc powder and the non-corrosive flux powder containing CsF are uniformly mixed together to be a powder mixture of brazing material and flux. In this regard, a mixing ratio of the zinc powder to the non-corrosive flux powder containing CsF is 40%:60% by weight.

This powder mixture is suspended in organic solvent such as alcohol or others to prepare a solution of the powder mixture composed of brazing material and flux. This solution is supplied to a spray nozzle and sprayed on the surface of the members 10 to 13 of the assembly. The spraying is carried out at a room temperature (normal temperature).

It is possible to apply the zinc powder as a low-melting point brazing material together with the non-corrosive flux powder to the surface of the members 10 to 13 of the assembly by merely spraying the solution at the room temperature in such a manner.

In this regard, after the solution of the powder mixture of the brazing material and the flux has been sprayed, the assembly may be heated to a temperature somewhat higher than the room temperature (for example, approximately 60° C.) to accelerate the drying of the powder mixture of the brazing material and the flux or improve the adhesive force.

Next, the assembly is conveyed into a brazing furnace to carry out the brazing process for the aluminum heat exchanger. Concrete conditions for this brazing process are as follows: the brazing temperature is 460° C., the brazing (heating) time is 1 minute and the atmosphere in the interior of the furnace is air.

In this brazing process, when the zinc powder as a low-melting point brazing material melts, the non-corrosive flux powder also melts to carry out the above-mentioned brazing accelerating operation, such as the removal of the oxidized film, whereby the respective members 10 to 13 in the heat exchanger are bonded together.

The effects of this embodiment are as follows:

(1) As the brazing of the heat exchanger assembly is carried out by heating the members 10 to 13 of the heat exchanger assembly at a temperature (460° C.) higher than the melting point (419° C.) of the low-melting point brazing material (zinc) and the melting activity-initiating point (420° C.) of the non-corrosive flux containing CsF after the solution of the powder mixture of brazing material and flux preliminarily prepared is sprayed on the surface of the respective members 10 to 13 of the heat exchanger assembly, it is possible to suppress the reduction of the mechanical strength of the respective aluminum members 10 to 13 due to the thermal history thereof as much as possible.

That is, the heating of the assembly at a temperature higher than the melting point of the brazing material (zinc) is done only once during the brazing, and the heating temperature during the brazing is largely lower than the usual heating temperature (approximately 600° C.) in the conventional brazing of the aluminum heat exchanger by the combination of the low-temperature active type non-corrosive flux containing CsF and the low-melting point brazing material. Accordingly, in this embodiment, it is possible to minimize the reduction of mechanical strength of the aluminum members 10 to 13 caused by the thermal history, and thereby to effectively reduce a wall thickness of the aluminum members 10 to 13.

Also, it is possible to effectively save the heat energy for the brazing, In this regard, in the above-mentioned conventional brazing method, an Al-Si type brazing material and a KF—AlF₃ type flux are combined.

(2) As the powder mixture of the brazing material and the flux is preliminarily prepared and applied to the surface of the members 10 to 13 of the heat exchanger assembly as described above, it is possible to apply the brazing material and the flux at the same time. Accordingly, in comparison with the conventional method wherein the brazing material and the flux are separately applied to the surface of the members 10 to 13 of the heat exchanger assembly, it is possible to simplify the manufacturing process of the aluminum heat exchanger.

(3) As the low-melting point brazing material consisting of zinc is better in melt-fluidity during the brazing than the conventional Al—Si type brazing material, it is possible to ensure the favorable brazing ability even if the atmosphere in the interior of the furnace is air. Accordingly, in comparison with the method wherein the furnace atmosphere is a reductive atmosphere such as nitrogen gas or a low-dew point dehumidified air, it is possible to effectively reduce the plant cost for the brazing.

(4) Zinc diffuses over the surface of the respective aluminum member 10 to 13 by the heat during the brazing to form a zinc-diffusion layer. The zinc-diffusion layer exhibits the sacrificial corrosive action for aluminum mother material to prevent through-holes forming in the aluminum mother material due to the corrosion (pitting), whereby the anti-corrosive property of the aluminum heat exchanger is improved.

Further, as the heating of the brazing material (zinc) at a temperature higher than the melting point thereof is done only once, the diffusion concentration or the diffusion depth of the zinc-diffusion layer is easily adjustable.

(5) As the non-corrosive flux containing CsF is not corrosive to the aluminum members 10 to 13 and the brazing material (zinc), even if the flux component is left after the brazing, the corrosion resistance of the aluminum heat exchanger is not adversely effected.

Thereby, it is unnecessary to rinse the aluminum heat exchanger after the brazing. Accordingly, the aluminum heat exchanger taken out from the furnace after the brazing can be directly transferred to a post process such as a coating, whereby it is possible to further simplify the manufacturing process of the aluminum heat exchanger.

In this regard, while pure zinc is used as the low-melting point brazing material in this embodiment, a zinc-aluminum alloy mainly composed of zinc may be used in place thereof. Particularly, it is possible to obtain a low-melting point brazing material having melting point of 382° C. when aluminum eutectic crystal alloy composed of zinc of 95% by weight and aluminum of 5% by weight is used.

While an amount of aluminum added to the zinc-aluminum alloy mainly composed of aluminum is approximately in a range from 2 to 6% by weight, a small amount of an element other than aluminum may be added to further lower the melting point of the low-melting point brazing material.

Also, while the powder mixture of brazing material and flux is applied to the surface of the members 10 to 13 of the heat exchanger by spraying the solution of the powder mixture of brazing material and flux from the ejection nozzle to the surface of the members 10 to 13 in this embodiment, it may be possible to use methods other than spraying for applying the powder mixture.

For example, the powder mixture of brazing material and flux may be applied to the surface of the respective members 10 to 13 by dipping the heat exchanger assembly into the solution of the powder mixture of brazing material and flux.

Alternatively, the powder mixture of brazing material and flux may be applied to the surface of the members 10 to 13 by filling the powder mixture of brazing material and flux in a container to be randomly fluidized and leaving the heat exchanger assembly within the container for a predetermined period.

### Second Embodiment

In the first embodiment, the aluminum members such as a tube 10, fins 11 or refrigerant inlet/outlet pipes 12, 13 are assembled to form an assembly of a predetermined structure and then the powder mixture of brazing material and flux is applied to the surface of the assembly. Contrarily, in a second embodiment, the powder mixture of brazing material and flux is applied solely to the surface of the extrusion-molded tube 10.

The powder mixture used in the second embodiment may be the same as used in the first embodiment. However, as the tube 10 must be bent in a zigzag manner after the powder mixture of brazing material and flux has been applied, the powder mixture is liable to peel off from the tube during the bending process.

Accordingly, in the second embodiment, a binder, for imparting a suitable viscosity, such as a paint is added to a solution of the powder mixture of brazing material and flux to form a binder-containing mixture compound. The binder-containing mixture compound is a paint-like paste.

Concretely, this binder is preferably a thermosetting or photo-setting type binder mainly composed of methacrylate ester type polymer disclosed, for example, in Japanese Unexamined Patent Publication No. 2000-687.

The binder-containing mixture compound is coated on the surface of the tube 10 by using a rotating roll. That is, the rotating roll is disposed opposite to a flat surface of the tube 10, and presses the paint-like binder-containing mixture compound adhered to the circumferential surface of the rotating roll onto the flat surface of the tube 10 so that a thin film of the binder-containing mixture compound is coated on the outer surface of the tube 10. The tube 10 coated with the binder-containing mixture compound is wound on a take-up roll to form a coil.

When the tube 10 is bent in a zigzag manner, a predetermined length of the tube 10 coated with the mixture compound is rewound from the take-up roll and then subjected to the bending operation. Thereafter, the assembly of the heat exchanger is formed and then the brazing is carried out under the same condition as in the first embodiment.

### Other Embodiments

While the extrusion-molded flat multi-passage tube 10 is bent in a zigzag manner and the corrugated fins 11 are inserted between the adjacent parallel pieces of the tube and bonded together in the refrigerant condenser shown in FIG. 1, another aluminum heat exchanger is also well-known, wherein the flat multi-passage tube 10 is cut into a plurality of linear pieces which are then arranged parallel to each other, and one ends of the pieces are coupled to a first tank member and the other ends of the pieces are coupled to a second tank member. The inventive method is also applicable to the latter aluminum heat exchanger.

Instead of the flat multi-passage tube 10, a well-known flat tube constructed by bonding two thin aluminum sheet with each other may be used. Also, the tube 10 may be formed by folding a single thin aluminum sheet.

Also, other-shaped fins may be used instead of the wave-shaped corrugated fin 11.

1. A method for manufacturing an aluminum heat exchanger formed by brazing a plurality of aluminum members with each other, comprising the steps of:
applying a mixture of a low-temperature active type non-corrosive flux and a low-melting point brazing material consisting of zinc or zinc-aluminum alloy mainly composed of zinc to at least one of the plurality of aluminum members, and
brazing the plurality of aluminum members with each other by heating an assembly of the plurality of aluminum members at a temperature exceeding a melting activity-initiating point of the non-corrosive flux and a melting point of the low-melting point brazing material.

2. A method for manufacturing an aluminum heat exchanger as defined by claim 1, wherein the mixture is applied to the aluminum member at a temperature in the vicinity of the room temperature.

3. A method for manufacturing an aluminum heat exchanger as defined by claim 1, wherein the brazing is carried out in air.

4. A method for manufacturing an aluminum heat exchanger as defined by claim 1, wherein the brazing temperature is in a range from 400 to 530° C.

5. A method for manufacturing an aluminum heat exchanger as defined by claim 1, wherein the low-temperature active type non-corrosive flux is CsF-containing non-corrosive flux.

6. A method for manufacturing an aluminum heat exchanger as defined by claim 5, wherein a powder of the CsF-containing non-corrosive flux is mixed to a powder of the low-melting point brazing material at a ratio of 40 to 80% by weight.

7. A method for manufacturing an aluminum heat exchanger as defined by claim 1, wherein the plurality of aluminum members comprise at least one tube through which heat-exchanging fluid flows and fins bonded to the tube, and the tube and the fins are assembled to form a predetermined structure as an assembly, then the mixture is applied to the surface of the assembly, after which the brazing is carried out.

8. A method for manufacturing an aluminum heat exchanger as defined by claim 7, wherein the mixture is applied to the assembly by spraying a solution of the mixture to the assembly or dipping the assembly into the solution.

9. A method for manufacturing an aluminum heat exchanger as defined by claim 1, wherein the plurality of aluminum members comprise at least one tube through which heat-exchanging fluid flows and fins bonded to the tube, and
the mixture is applied to the surface of the tube existing alone, then the tube is assembled with the fins to form an assembly of a predetermined structure, after which the brazing is carried out.

10. A method for manufacturing an aluminum heat exchanger as defined by claim 9, wherein the mixture is added with a binder to have a predetermined viscosity, and is coated on the surface of the tube.
